(19) United States
(12) Patent Application Publication
(10) Pub. No.: US 2011/0242978 A1
(43) Pub. Date: Oct. 6, 2011

(54) SYSTEM AND METHOD FOR DYNAMICALLY ADJUSTING QUALITY OF SERVICE CONFIGURATION BASED ON REAL-TIME TRAFFIC

(75) Inventors: Thierry E. Klein, Fanwood, NJ (US); Atiya Suhail, Plano, TX (US)

(73) Assignee: Alcatel-Lucent USA, Incorporated, Murray Hill, NJ (US)

(21) Appl. No.: 12/751,626

(22) Filed: Mar. 31, 2010

(51) Int. Cl. H04L 12/24

(52) U.S. Cl. 370/235

(57) ABSTRACT

A system and method for dynamically adjusting QoS configuration and a network in which said system or said method is employed. In one embodiment, the system includes: (1) a QoS control engine configured to identify traffic types of packets conveyed through a network and maintain statistics indicating a traffic mix of the network and (2) a QoS configuration database coupled to the QoS control engine and configured to contain QoS configuration information corresponding to the traffic types and provide at least some of the QoS configuration information for carrying out QoS with respect to the network in response to a request from the QoS control engine.

### TECHNICAL FIELD

This application is directed, in general, to network management and, more specifically, to a system and method for dynamically adjusting Quality of Service (QoS) configuration based on real-time traffic.

### BACKGROUND

As the next generation of networking occurs, organizations are becoming increasingly reliant on their networks to deliver Internet Protocol (IP) communications and mission-critical information. With the trends towards IP telephony and converged applications becoming a reality, there is now a greater need to incorporate QoS into the network infrastructure. QoS comprises a set of mechanisms that gives priority to delay-sensitive applications and makes the network more efficient and reliable for all applications.

QoS is designed to prioritize traffic and allocate network resources so that information arrives smoothly and predictably at its destination. It enables traffic to be grouped into categories based on common characteristics, allowing prioritization and services to be applied at the user or application level. Priority levels range from “mission-critical”(highest priority) to “best effort” (lowest priority). While over-provisioning bandwidth is an alternative to using QoS, and is an effective way to manage bandwidth in some networks, it cannot provide any guarantees that delay-sensitive traffic, such as voice and video, will arrive at its destination as the sender intends. QoS can make more efficient use of bandwidth and traffic management without adding capacity, and is therefore an attractive way to meet the needs of delay-sensitive traffic and to make better use of enterprise resources (e.g., bandwidth and equipment investment).

The behavior of QoS in a given network is dependent upon its QoS configuration, which is a set of selectable QoS parameters. The QoS parameters tune QoS algorithms that determine the network's QoS behavior. No QoS configuration is optimum for all possible traffic scenarios. Therefore, QoS parameters should be selected based on an anticipated traffic scenario. Unfortunately, QoS algorithms are becoming more intricate, making QoS configuration far more complex. A typical network administrator, who has little or no knowledge of QoS algorithms, stands little chance of effectively configuring QoS parameters and cannot be expected to adjust the QoS parameters as the traffic scenario changes.

### SUMMARY

One aspect provides a system for dynamically adjusting QoS configuration and a network in which said system or said method is employed. In one embodiment, the system includes: (1) a QoS control engine configured to identify traffic types of packets conveyed through a network and maintain statistics indicating a traffic mix of the network and (2) a QoS configuration database coupled to the QoS control engine and configured to contain QoS configuration information corresponding to the traffic types and provide at least some of the QoS configuration information for carrying out QoS with respect to the network in response to a request from the QoS control engine.

Another aspect provides a method of dynamically adjusting QoS configuration. In one embodiment, the method includes: (1) identifying traffic types of packets conveyed through a network, (2) maintaining statistics indicating a traffic mix of the network and (3) automatically providing one of a stored plurality of QoS configurations for carrying out QoS with respect to the network based on the statistics.

Yet another aspect provides a network configured to carry a plurality of traffic types and including: (1) a plurality of nodes and (2) a system, cooperable with at least one of the nodes, for dynamically adjusting QoS configuration, having: (2a) a QoS control engine configured to identify traffic types of packets conveyed through a network based on DiffServ Control Point (DSCP) values therein and maintain statistics indicating a traffic mix of the network and (2b) a QoS configuration database coupled to the QoS control engine and configured to contain QoS configuration information corresponding to the traffic types and provide at least some of the QoS configuration information for carrying out QoS with respect to at least the one of the nodes in response to a request from the QoS control engine.

### BRIEF DESCRIPTION

Reference is now made to the following descriptions taken in conjunction with the accompanying drawings, in which:

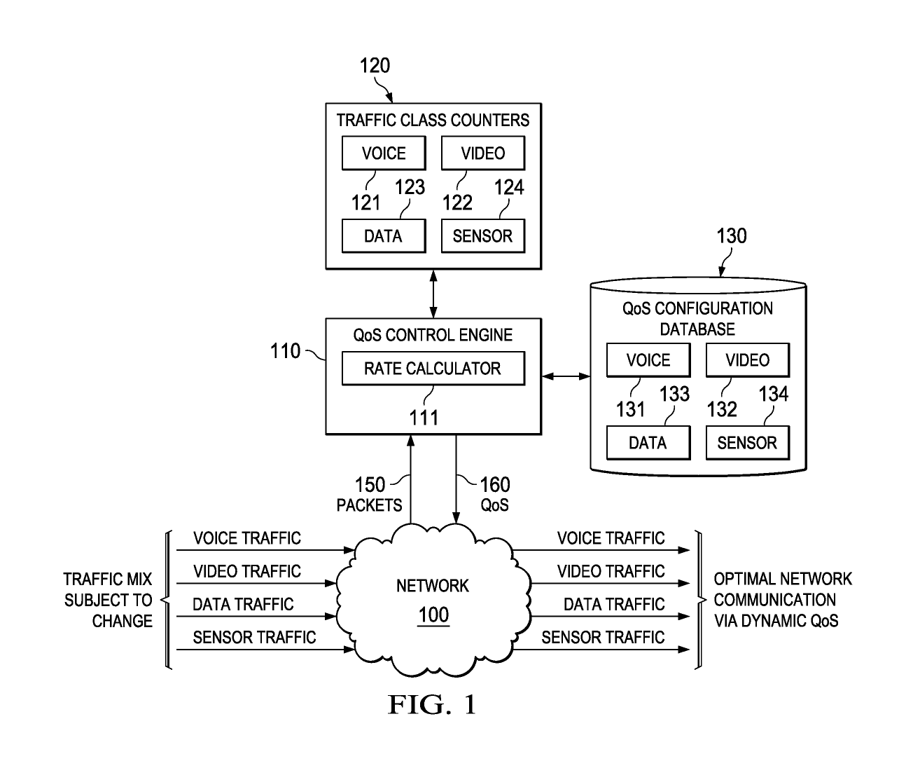

FIG. 1 is a block diagram of one embodiment of a network within which a system or method constructed or carried out according to the teachings herein may be employed together with one embodiment of such system; and

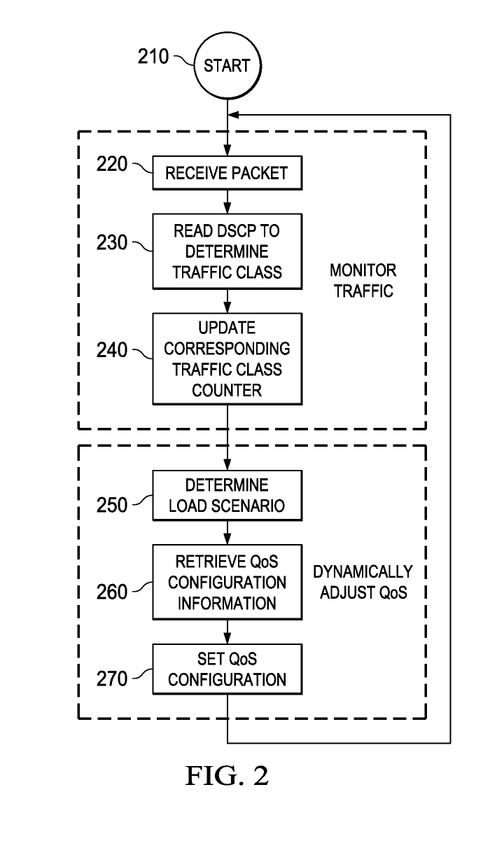

FIG. 2 is a flow diagram of one embodiment of a method of dynamically adjusting QoS configuration based on real-time traffic.

### DETAILED DESCRIPTION

Various conventional network architectures provide flow-based or class-based QoS mechanisms. Flow-based mechanisms include Integrated Services (IntServ or IS), which employs the Resource Reservation Protocol (RSVP) to make reservations of network resources for each specific flow of data through the network.

Class-based mechanisms include Differentiated Services (DiffServ or DS), sometimes referred to as “provisioned QoS.” Instead of reserving resources for specific flows, DiffServ divides traffic into prioritized Classes Of Service (COSes) and then treats the classes as aggregate flows on a hop-by-hop basis. The current IP implementations of DiffServ defines eight COSes. To achieve this, DiffServ provides a standard way of encoding the existing type-of-service (TOS) field in an IP packet header as a DS byte, with the six most significant bits being defined as DSCPs. Additional information in the DS byte defines the Per Hop Behavior (PHB).

Compared to IntServ and RSVP, DiffServ requires less network overhead to implement. As a result, DiffServ has received widespread support among network equipment manufacturers, particularly those that manufacture equipment for larger networks. DiffServ works well in networks having routers from different manufacturers, as long as the routers support DiffServ.

Conventional tools exist for manually configuring QoS in networks employing DiffServ. However, no tools exist that provide automatic, dynamic adjustment of QoS configuration. Further, no tools exist that provide adjustment of QoS configuration based on the real-time traffic load. Described herein are various systems and methods whereby the real-time traffic load on a network can be determined and the QoS configuration adjusted based on that traffic load.

In various embodiments described herein, QoS configuration information is stored in a QoS configuration database. In certain embodiments, the QoS configuration information includes sets of values for different traffic scenarios, which are the QoS configurations themselves. In certain other embodiments, the QoS configuration information includes values that can be collected together and perhaps modified (e.g., by interpolation, extrapolation or some other function or relation) to generate a QoS configuration dynamically. In some embodiments, the QoS configurations (whether they are predetermined, stored in the QoS configuration database ahead of time and bodily retrieved or generated dynamically based on certain configuration information contained in the QoS configuration database) correspond to traffic mixes that are dominated by a single traffic type (e.g., voice-centric, video-centric, sensor-centric or data-centric). In other embodiments, the QoS configurations correspond to hybrid traffic mixes (those in which plural traffic types dominate, e.g., voice/video-centric, or sensor/data-centric). Regarding the dynamic generation of QoS configurations, it should be stated that QoS configurations are often difficult to tune and frequently require extensive simulations. As a result, generating QoS configurations dynamically from configuration information, as opposed to bodily retrieving a predetermined QoS configuration, may be difficult.

A QoS control engine at least continually (perhaps with interruption) monitors the network's traffic load. In some embodiments, the QoS control engine continuously (without interruption) monitors the traffic load. The QoS control engine also at least occasionally (at least once, either aperiodically or periodically if more than once, and perhaps in response to an explicit command or predefined network condition) determines whether or not the traffic load scenario has changed. In some embodiments, the QoS control engine periodically (repeatedly at regular intervals) determines whether or not the traffic load scenario has changed. If the QoS control engine determines that the traffic load scenario has changed, the QoS control engine causes a corresponding, appropriate QoS configuration to be generated (e.g., retrieved) from the QoS configuration database and employed to adjust the network's QoS.

For example, if the QoS of a network is initially established assuming that the network will be predominantly carrying voice traffic (“voice-centric”), a QoS configuration appropriate for voice-centric traffic is properly employed initially to set the network's QoS. However, perhaps by automated traffic analysis as taught herein, it may thereafter be discovered that the network is instead predominantly carrying video traffic (“video-centric”). As described herein, a different QoS configuration may then be employed to adjust the network's QoS. Thus the QoS configuration is dynamically adjusted such it remains appropriate for the traffic that the network is currently handling. QoS improves as a result.

A network may, for example, implement DiffServ-based QoS and support 14 different traffic classes. Each traffic class would therefore be mapped to a unique DSCP. According to DiffServ, all packets belonging to the same traffic class are provided the same forwarding treatment. Although the network can employ different QoS algorithms, the network in this example employs the well-known Hierarchical Token Bucket (HTB) QoS algorithm for bandwidth sharing among different applications. The HTB algorithm has various QoS parameters such as: priority, assured rate, ceiling rate, queue length and estimator value. The optimal value of each HTB QoS parameter depends upon the traffic scenario. As stated above, a single QoS configuration of parameters cannot be optimal for all traffic scenarios. Conventionally, a network administrator may manually select from various default QoS configurations (e.g., voice-centric, video-centric, sensor-centric and data-centric configurations) a QoS configuration appropriate for a given expected traffic mix. As time passes, the traffic mix is subject to change. For example, the traffic mix that is video-centric at one time may later become voice-centric. Consequently, the configuration parameters that are tuned for a video-centric traffic mix will not be satisfactory for a voice-centric or video/sensor-centric traffic mix. Conventionally, the network administrator would have first to detect that the traffic mix has changed, next identify the new traffic mix and then manually select and load the configuration that matches the new traffic mix.

In contrast, the various systems and methods are introduced herein whereby the real-time traffic load on a network can be determined and the QoS configuration adjusted based on that traffic load. Turning now to FIG. 1, illustrated is a block diagram of one embodiment of a network 100 within which a system or method constructed or carried out according to the teachings herein may be employed. In the embodiment of FIG. 1, a QoS control engine 110 is associated with a plurality of traffic class counters 120 and a QoS configuration database 130. The traffic class counters 120 include a voice traffic counter 121, a video traffic counter 122, a data traffic counter 123 and a sensor traffic counter 124. The QoS configuration database 130 includes a voice-centric QoS configuration 131, a video-centric QoS configuration 132, a data-centric QoS configuration 133 and a sensor-centric QoS configuration 134. In alternative embodiments, the QoS configuration database 130 alternatively or additionally contains QoS configuration information that the QoS control engine 110 can use to generate a QoS configuration dynamically.

As FIG. 1 shows, the network 100 receives, conveys and transmits a mix of traffic including voice traffic, video traffic, data traffic and sensor traffic. Packets 150 conveying the mix of traffic are provided to the QoS control engine 110, where they are identified in terms of their traffic class, and corresponding ones of the traffic class counters 120 (i.e., the voice traffic counter 121, the video traffic counter 122, the data traffic counter 123 and the sensor traffic counter 124) are updated accordingly. In the illustrated embodiment, all packets 150 are provided to the QoS control engine 110 as they transit the network 100. The QoS control engine 110 then reads the DSCP value of each packet. In the illustrated embodiment, the QoS control engine 110 reads the DSCP value of each packet entering the node on every access interface. Thus, the traffic class counters 120 are able to maintain running, real-time statistics indicating the traffic mix.

As described in greater detail below, the QoS control engine 110 employs the traffic class counters 120 to determine the traffic mix and retrieves a corresponding QoS configuration (i.e., the voice-centric QoS configuration 131, the video-centric QoS configuration 132, the data-centric QoS configuration 133 and the sensor-centric QoS configuration 134) from the QoS configuration database 130. Alternatively, the QoS control engine 110 may dynamically generate an appropriate QoS configuration from QoS configuration information contained in the QoS configuration database 130, e.g., by assembling, modifying or assembling and modifying the information in some way. The QoS control engine 110 may employ a rate calculator 111 to keep a running count of packet rate to determine how the traffic mix changes over time. As FIG. 1 indicates, the QoS control engine 110 then employs the retrieved QoS configuration to provide QoS 160 to the network, tailoring the manner in which the network prioritizes its conveyance of the traffic mix.

In one embodiment, an example network in which the system or method is employed has a QoS model that supports 14 traffic classes. Table 1, below, shows one example of 14 traffic classes (column 2) mapped to 14 unique DSCPs (column 3) and divided into five general traffic types (column 1). Those skilled in the art will understand that other embodiments may have different types and numbers of general traffic types, categories and numbers of traffic classes and mappings to DSCPs.

TABLE 1
Traffic Types Supported by an Example Network

| General Traffic Type | Traffic Class | DSCP |
|---|---|---|
| Network Management | Routing and Network Control | 110000 |
| Network Management | Distress Call | 101110 |
| | Evacuation Command | |
| | Critical Communication | |
| Voice | Voice - High Priority | 100010 |
| Voice | Voice - Medium Priority | 100100 |
| Voice | Voice - Low Priority | 100110 |
| Network Management | SIP Signaling | 100001 |
| Sensor | Vital Sensor Data - High Priority | 011010 |
| Sensor | Vital Sensor Data - Medium Priority | 011100 |
| Sensor | Vital Sensor Data - Low Priority | 011110 |
| Video | Video - High Priority | 010010 |
| Video | Video - Medium Priority | 010100 |
| Video | Video - Low Priority | 010110 |
| Data | Database Synchronization | 010000 |
| Data | Best Effort | 000000 |

In the embodiment of FIG. 1, the QoS control engine 110 reads the DSCP value of each packet entering a network node on every access interface. In one embodiment, each node has six access interfaces. Table 2, below, sets forth an example embodiment of a node illustrating how such interfaces may be distributed.

TABLE 2
Interfaces in an Example Node

| Interface Types | Number of Interfaces |
|---|---|
| Ethernet | 2 |
| Backhaul | 1 |
| Mesh (Wi-Fi) | 2 |
| WiMAX | 1 |

As described above, one embodiment provides four default QoS configurations, each corresponding to a different traffic model: voice-centric, video-centric, data-centric and sensor-centric. Accordingly, the traffic class counters 120 include four separate counters (i.e., the voice traffic counter 121, the video traffic counter 122, the data traffic counter 123 and the sensor traffic counter 124), one for each general traffic type. Table 3, below, shows the correspondence among the traffic mix (column 1), the QoS configuration (column 2) and the traffic class counter (column 3).

TABLE 3
Configuration Templates for Different Traffic Models

| | | Traffic Class |
|---|---|---|
| Traffic Mix | QoS Configuration | Counter |
| Voice-Centric Traffic | Voice-centric QoS | Voice Counter |
| | Configuration | |
| Video-Centric Traffic | Video-centric QoS | Video Counter |
| | Configuration | |
| Data-Centric Traffic | Data-centric QoS | Data Counter |
| | Configuration | |
| Sensor-Centric Traffic | Sensor-centric QoS | Sensor Counter |
| | Configuration | |

With reference to Tables 1-3, when a packet arrives on any of the access interfaces of a given network node, the DSCP of the incoming packet is read. If the DSCP of the incoming packet maps to a voice traffic type (i.e., Voice—High Priority, Voice—Medium Priority or Voice—Low Priority), the voice counter is updated. If the DSCP of the incoming packet maps to a video traffic type (i.e., Video—High Priority, Video—Medium Priority or Video—Low Priority traffic), the video counter is updated. If the DSCP of the incoming packet maps to a sensor traffic type (i.e., Sensor—High Priority, Sensor—Medium Priority or Sensor—Low Priority), the sensor counter is updated. If the DSCP maps to a data traffic type (i.e., Database Synchronization or Best Effort), the data counter is updated. In this example, if the DSCP maps to a network management traffic type (i.e., Routing and Network Control; Distress Call, Evacuation Command and Critical Communication or Session Initiation Protocol Signaling), no counters are updated. The reason for this is an intention not to base the selection of an appropriate QoS configuration on the payload packets the network carries exclusive of the packets representing network overhead.

Occasionally, and perhaps periodically, the QoS control engine 110 compares the counters for voice, video, sensor and data traffic (i.e., the voice counter 121, the video counter 122, the data counter 123 and the sensor counter 124) to determine whether the traffic has tended to be voice-centric, video-centric, sensor-centric or data-centric. If the traffic model has changed, the QoS control engine 110 changes the values of parameters in accordance with that of a more appropriate QoS configuration. The counters are then reset and the same process is repeated at every interval.

FIG. 2 is a flow diagram of one embodiment of a method of dynamically adjusting QoS configuration based on real-time traffic. The method is generally divided into two portions: a traffic monitoring portion and a dynamic QoS adjusting portion. FIG. 2 indicates these two portions in broken-line.

The method begins in a start step 210. In a step 220, a packet is received. In a step 230, the packet is read to determine the traffic class to which the packet belongs. In one embodiment, the DSCP is read to determine the traffic class to which the packet belongs. In a step 240, a traffic counter corresponding to the traffic class to which the packet belongs is updated. The steps 220, 230, 240 are repeated as further packets are received.

In a step 250, the load scenario is determined by employing the counters and one of many possible techniques for comparing the values of the counters to one another. In a step 260, QoS configuration information is retrieved. The QoS configuration information may be a predetermined QoS configuration or values that can be employed to generate a QoS configuration appropriate to the load scenario determined in the step 250. In a step 270, the QoS configuration of the network is set. In various embodiments, the traffic continues to be monitored and QoS continually dynamically adjusted in accordance therewith.

Having described various embodiments of a system and method, an example embodiment will now be described. Traffic class counters for voice, video, sensor and data traffic are established for a given network 100. The QoS control engine 110 then examines the DSCPs of every packet entering a given node of the network 100 and increments a corresponding one of the counters accordingly.

The QoS control engine 110 reads the counters every second. After the QoS control engine 110 reads the counters, it resets them to zero. The values read from the counters indicate the average rate for each traffic type, expressed in packets per second. The rate calculator 111 then computes an exponential moving average rate of packets, for each traffic-type, using the following formula:

EMA_Avg_Pkt_Rate₍ₜ₎=Current_Avg_Pkt_Rate*α+EMA_Avg_Pkt_Rate_{(t-T)},

where α=2/(1+N) and N=the number of time periods included in the window of the moving average.

The configuration selection module of the QoS control engine 110 reads the EMA_Avg_Pkt_Rate for each traffic type every T units of time. The traffic type having the highest EMA_Avg_Pkt_Rate is selected as the candidate. If multiple traffic types have the same EMA_Avg_Pkt_Rate, each of the multiple traffic types are selected as candidates. The QoS control engine 100 keeps a running tally of the selection of candidates.

After N EMA_Avg_Pkt_Rate readings are completed, the example embodiment employs the following technique to determine which QoS configuration should be selected.
Step 1—In the N iterations, the traffic type that was selected as the candidate the most times is the final candidate.
Step 2—In case of a tie, the traffic type that was selected as the candidate the most times consecutively is the final candidate.
Step 3—The QoS configuration corresponding to the final candidate is selected for loading.
   Steps 1-3 are repeated every M*N*T units of time. The load scenario is determined each time steps 1-3 are repeated.

Table 4, below, tallies example results for seven iterations (N=7) of candidate selection.

TABLE 4
Candidate Selection for Loading QoS configuration

| Traffic | | | | |
|---|---|---|---|---|
| Type | Voice | Video | Sensor | Data |
| Iteration 1 | Candidate | Candidate | Not | Not |
| | | | Candidate | Candidate |
| Iteration 2 | Not | Candidate | Not | Not |
| | Candidate | | Candidate | Candidate |
| Iteration 3 | Candidate | Not | Not | Not |
| | | Candidate | Candidate | Candidate |
| Iteration 4 | Not | Candidate | Not | Candidate |
| | Candidate | | Candidate | |
| Iteration 5 | Candidate | Not | Candidate | Not |
| | | Candidate | | Candidate |
| Iteration 6 | Candidate | Candidate | Not | Not |
| | | | Candidate | Candidate |
| Iteration 7 | Candidate | Candidate | Not | Not |
| | | | Candidate | Candidate |

As Table 4 indicates, Step 1 of the technique described above selects voice and video traffic types as final candidates, as both voice and video were selected as candidates the most (five) times. Step 2 of the technique then selects voice as the final candidate because voice was consecutively selected as the final candidate the most times. Step 3 of the technique then concludes that the current load scenario is voice-centric and causes a voice-centric QoS configuration (i.e., the voice-centric QoS configuration 131) to be loaded.

Those skilled in the art to which this application relates will appreciate that other and further additions, deletions, substitutions and modifications may be made to the described embodiments.

What is claimed is:

1. A system for dynamically adjusting QoS configuration, comprising:
a QoS control engine configured to identify traffic types of packets conveyed through a network and maintain statistics indicating a traffic mix of said network; and
a QoS configuration database coupled to said QoS control engine and configured to contain QoS configuration information corresponding to said traffic types and provide at least some of said QoS configuration information for carrying out QoS with respect to said network in response to a request from said QoS control engine.

2. The system as recited in claim 1 further comprising traffic class counters associated with said QoS control engine and configured to allow said QoS control engine to maintain said statistics.

3. The system as recited in claim 1 wherein said traffic types are selected from the group consisting of:
voice,
video,
data, and
sensor.

4. The system as recited in claim 1 wherein said QoS configuration information includes QoS configurations selected from the group consisting of:
a voice-centric QoS configuration,
a video-centric QoS configuration,
a data-centric QoS configuration, and
a sensor-centric QoS configuration.

5. The system as recited in claim 1 wherein said QoS control engine is configured to identify said traffic types based on DiffServ Control Point values in said packets.

6. The system as recited in claim 1 wherein said QoS control engine is configured to compute a moving average rate for each of said traffic types and evaluate candidate traffic mixes based thereon.

7. The system as recited in claim 1 wherein said QoS control engine is further configured to identify said traffic types of all packets conveyed through a node of said network and periodically compute a moving average rate for each of said traffic types.

8. A method of dynamically adjusting QoS configuration, comprising:
identifying traffic types of packets conveyed through a network;
maintaining statistics indicating a traffic mix of said network; and
automatically providing at least some of said QoS configuration information for carrying out QoS with respect to said network based on said statistics.

9. The method as recited in claim 8 wherein said maintaining comprises updating traffic class counters and said automatically providing comprises an action selected from the group consisting of:
automatically providing one of a stored plurality of QoS configurations, and
automatically providing values that can be employed to generate a QoS configuration dynamically.

10. The method as recited in claim 8 wherein said traffic types are selected from the group consisting of:
voice,
video,
data, and
sensor.

11. The method as recited in claim 8 wherein said QoS configuration information includes QoS configurations selected from the group consisting of:
a voice-centric QoS configuration,
a video-centric QoS configuration,
a data-centric QoS configuration, and
a sensor-centric QoS configuration.

12. The method as recited in claim 8 wherein said identifying comprises identifying said traffic types based on DiffServ Control Point values in said packets.

13. The method as recited in claim 8 further comprising:
computing a moving average rate for each of said traffic types; and
evaluating candidate traffic mixes based thereon.

14. The method as recited in claim 8 wherein said identifying comprises identifying said traffic types of all packets conveyed through a node of said network and said method further comprises periodically computing a moving average rate for each of said traffic types.

15. A network configured to carry a plurality of traffic types and comprising:
a plurality of nodes; and
a system, cooperable with at least one of said nodes, for dynamically adjusting QoS configuration, including:
a QoS control engine configured to identify traffic types of packets conveyed through a network based on DiffServ Control Point values therein and maintain statistics indicating a traffic mix of said network, and
a QoS configuration database coupled to said QoS control engine and configured to contain QoS configuration information corresponding to said traffic types and provide at least some of said QoS configuration information for carrying out QoS with respect to at least said one of said nodes in response to a request from said QoS control engine.

16. The network as recited in claim 15 wherein said system further includes traffic class counters associated with said QoS control engine and configured to allow said QoS control engine to maintain said statistics.

17. The network as recited in claim 15 wherein said traffic types are selected from the group consisting of:
voice,
video,
data, and
sensor.

18. The network as recited in claim 15 wherein said QoS configuration information includes QoS configurations selected from the group consisting of:
a voice-centric QoS configuration,
a video-centric QoS configuration,
a data-centric QoS configuration, and
a sensor-centric QoS configuration.

19. The network as recited in claim 15 wherein said QoS control engine is configured to compute a moving average rate for each of said traffic types and evaluate candidate traffic mixes based thereon.

20. The network as recited in claim 15 wherein said QoS control engine is further configured to identify said traffic types of all packets conveyed through a node of said network and periodically compute a moving average rate for each of said traffic types.
